(19) United States
(12) Patent Application Publication
(10) Pub. No.: US 2004/0199723 A1
(43) Pub. Date: Oct. 7, 2004

(54) Low-power cache and method for operating same

(76) Inventor: Charles F. Shelor, Arlington, TX (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/406,482

(22) Filed: Apr. 3, 2003

(51) Int. Cl. G06F 12/00

(52) U.S. Cl. 711/128; 711/144

(57) ABSTRACT

A cache is provided that comprises a plurality of cache blocks that are independently selected using a direct-mapped cache access, with each block capable of storing a plurality of cache lines and having a plurality of outputs. The cache further includes comparison logic associated with each of the plurality of cache blocks, each comparison logic having a plurality of inputs for receiving the plurality of outputs of the associated cache block and configured to compare the plurality of outputs of the associated cache block with a value on a portion of an address bus that is input to the cache. Finally, the cache includes output logic for outputting from the cache an output from the comparison logic that is associated with a selected cache block. A related method for caching data is also provided.

### FIELD OF THE INVENTION

The present invention generally relates to cache memories, and more particularly to a low-power cache memory and method for controllably-operating a cache.

### BACKGROUND

A driving force behind computer-system innovation (or other processor-based systems) has been the demand for faster and more powerful processing capability. A major bottleneck in computer speed has historically been the speed with which data can be accessed from memory, referred to as the memory access time. The microprocessor, with its relatively fast processor cycle times, has frequently been delayed by the use of wait states during memory accesses to account for the relatively slow memory access times. Therefore, improvement in memory access times has been one of the major areas of research in enhancing computer performance.

In order to bridge the gap between fast-processor cycle times and slow-memory access times, cache memory was developed. As is known, a cache memory is a small amount of very fast, and relatively expensive, zero wait-state memory that is used to store a copy of frequently accessed code and data from main memory. A processor can operate out of this very fast memory and thereby reduce the number of wait states that must be interposed during memory accesses. When the processor requests data from memory and the data resides in the cache, then a cache read hit takes place, and the data from the memory access can be returned to the processor from the cache without incurring wait states. If the data is not in the cache, then a cache read miss takes place. In a cache read miss, the memory request is forwarded to the system, and the data is retrieved from main memory, as would normally be done if the cache did not exist. On a cache miss, the data that is retrieved from memory is provided to the processor and is also written into the cache due to the statistical likelihood that this data will be requested again by the processor.

An efficient cache yields a high “hit rate,” which is the percentage of cache hits that occur during all memory accesses. When a cache has a high hit rate, the majority of memory accesses are serviced with zero wait states. The net effect of a high cache hit rate is that the wait states incurred on a relatively infrequent miss are averaged over a large number of zero wait state cache hit accesses, resulting in an average of nearly zero wait states per access. Although processor caches are perhaps the best known, other caches are known and used as well. For example, I/O (input/output) caches are known for buffering and caching data between a system bus and an I/O bus.

Whether it is a processor cache, an I/O cache, or some other type of cache memory, important considerations in cache performance are the organization of the cache and the cache management policies that are employed in the cache. Cache memories are typically organized in a direct-mapped memory structure, a set-associative memory structure, or a fully-associative memory structure.

A direct-mapped cache provides the simplest and fastest cache memory, but severely limits the number of cache locations where a particular data item may reside to only one location. When two or more heavily-used data items map to the same location in a direct-mapped cache, and these data items are used by a program in a cyclic manner, as in a loop, cache thrashing occurs. Thrashing, in the context of a cache memory, occurs when the cache is spending significant time swapping cache lines containing referenced data items in and out of the cache memory in response to memory references by the CPU. In particular, as each data item is referenced, it displaces its predecessor, causing a relatively slow main memory access. Cache thrashing can severely degrade program execution speed by forcing excessive main memory accesses.

A set-associative memory structure uses a portion of the address to access a set of data blocks. Another segment of the address is then used for comparison with a tag field in each block of the set of data blocks. If the tag field of one of the blocks in the set of data blocks matches the address segment, then the data from that block is used for subsequent processing. Unlike a set-associative structure, in a fully-associative memory structure, the memory structure effectively has one set with a large number of blocks within the set. Data can be written to or read from any block in the single set.

Of the three types of cache structures, direct-mapped cache structures are the simplest to implement and realize the fastest accesses. Set-associative caches, however, are more complex and therefore expensive to implement. As cache size increases, this complexity becomes excessive and expensive, particularly in fully-associative caches. Further, the hit rate of set-associative caches is only slight less that that of fully-associative caches. Therefore, the lower complexity and faster access speeds of set-associative caches (as opposed to fully-associative caches), generally makes them a more desirable alternative, particularly as the cache size increases.

With the foregoing by way of introduction, reference is now made to FIG. 1, which is a block diagram illustrating a 16-way set associative cache, as implemented in known, prior-art systems. Inside the cache 10, are a plurality of cache blocks 12, 14, 16, and 18. The number of cache blocks may vary from system to system, but are typically used for faster operation and lower complexity. In this regard, a cache having four blocks of four kilobytes each runs faster than a cache having a single block of 16 kilobytes. Although implementation details may differ from cache to cache, the general structure and operation of cache blocks 12, 14, 16, and 18 are known by persons skilled in the art, and therefore need not be described herein. Basically, each cache block includes a data area, a tag area, as well as control logic. Assume, for example, that each cache block of FIG. 1 includes 32 lines (cache lines) of data, with each cache line storing eight words (a word being four 8-bit bytes). Further, assume that each cache block has four sets of such data areas. Each cache block, then, would contain four kilobytes of data.

As mentioned above, a cache is a high-speed memory, that speeds accesses to main memory, particularly when well designed to have a high “hit” rate. As is known, an address bus 20 is input to the cache. If valid data corresponding to the value carried on address line 20 is stored within the cache, then that data is output on the cache output 38. The address bus 20 is coupled to each of the cache blocks, and the least significant bits of the address bus are used to access data stored within the data area of the cache blocks, corresponding to the address on the least significant bits. When data is written into the data area of a cache block, the most significant bits of the address bus are written into a corresponding location (i.e., a location corresponding to the least significant bits used for accessing and storing the data) in a tag area of the cache block.

As is known, a cache controller (not shown herein) controls the algorithm or methodology by which data is accessed or stored among the various cache blocks 12, 14, 16, and 18. There are a variety of known algorithms and methodologies for implementing this control, which will be understood by persons skilled in the art, and therefore these algorithms or methods of control need not be described herein. When an address value is placed on address bus 20 in connection with a data read operation, the least significant bits of the address bus 20 are used to, access corresponding data locations within each cache block.

In the illustration of FIG. 1, each cache block has four internal data areas. Therefore, each cache block generates four outputs. As illustrated in connection with cache block 12, the four outputs are denoted with reference numerals 22, 24, 26, and 28. Data from within the data area at the location corresponding to the least significant bits will be placed on an output from the cache block 12. Since the cache block 12 includes four internal data areas, there will be four data values (one read from each area) output on the output lines from cache block 12. Likewise, the tag values that are stored in the corresponding tag memory area (corresponding to the least significant bits) will be output on each of the four outputs as well. In this regard, when data is written into the data area, the MSBs of the address bus are written into the corresponding location of the tag area.

Further, one or more status bits are output on each of the outputs 22, 24, 26, and 28 as well. In this regard, one status bit includes an indication as to whether the data that was retrieved from the particular location is valid. Therefore, for any read instruction seeking to read from memory, each cache block 12, 14, 16, and 18 outputs four distinct values. A logic block 35 then performs a 16-way comparison of the tag portion of each of these sixteen outputs with the most significant bits that are contained on the address bus 20. If there is a match, and the status bit(s) for the data corresponding to the match indicates that the data is valid, then the cache 10 outputs the data on its output 38. As is known, one or more status bits are also output along with the data. If, however, there is no “hit” (i.e., match between the most significant bits of the address bus 20 and the tag portion of one of the valid cache block outputs), then the data sought to be read must be retrieved from the system or main memory.

During operation, the various circuit and logic elements within the cache 10 are all in a substantially constant state of operation. As is known, battery-operated, processor-driven portable electronic devices (e.g., personal digital assistants, cell phones, MP3 players, etc.) continue to proliferate. There is a corresponding desire to lower the power consumption of these devices, so as to extend the battery life of the batteries that power the devices. As cache sizes increase, the amount of power required to operate the cache also increases. Therefore, there is a desire to improve the structure and operation of cache memories to realize lower-power operation.

### SUMMARY OF THE INVENTION

Certain objects, advantages and novel features of the invention will be set forth in part in the description that follows and in part will become apparent to those skilled in the art upon examination of the following or may be learned with the practice of the invention. The objects and advantages of the invention may be realized and obtained by means of the instrumentalities and combinations particularly pointed out in the appended claims.

To achieve the advantages and novel features, the present invention is generally directed to a novel cache architecture and method for caching, which achieves a substantially reduced power-consumption level. In one embodiment, a cache comprises a plurality of cache blocks that are independently selected using a direct-mapped cache access, with each block capable of storing a plurality of cache lines and having a plurality of outputs. The cache further includes comparison logic associated with each of the plurality of cache blocks, each comparison logic having a plurality of inputs for receiving the plurality of outputs of the associated cache block and configured to compare the plurality of outputs of the associated cache block with a value on a portion of an address bus that is input to the cache. Finally, the cache includes output logic for outputting from the cache an output from the comparison logic that is associated with a selected cache block.

In another embodiment, a method is provided for caching data. The method operates to directly map an address input to the cache to one of a plurality of cache blocks, each cache block having n outputs, and process the n outputs of the directly-mapped cache as an n-way set associative cache.

### DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a block diagram illustrating a 16-way fully-associative cache as is known in the prior art.

FIG. 2 is a block diagram illustrating the architecture of a cache memory constructed in accordance with an embodiment of the present invention.

FIG. 3 is a block diagram illustrating one allocation for bits within a 32-bit address, as utilized in connection with an embodiment of the present invention.

FIG. 4 is a block diagram illustrating a cache memory architecture constructed in accordance with an embodiment of the present invention.

FIG. 5 is a flowchart illustrating the top-level functional operation of a cache memory constructed in accordance with an embodiment of the invention.

### DETAILED DESCRIPTION

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary, the intent is to cover all alternatives, modifications and equivalents included within the spirit and scope of the invention as defined by the appended claims.

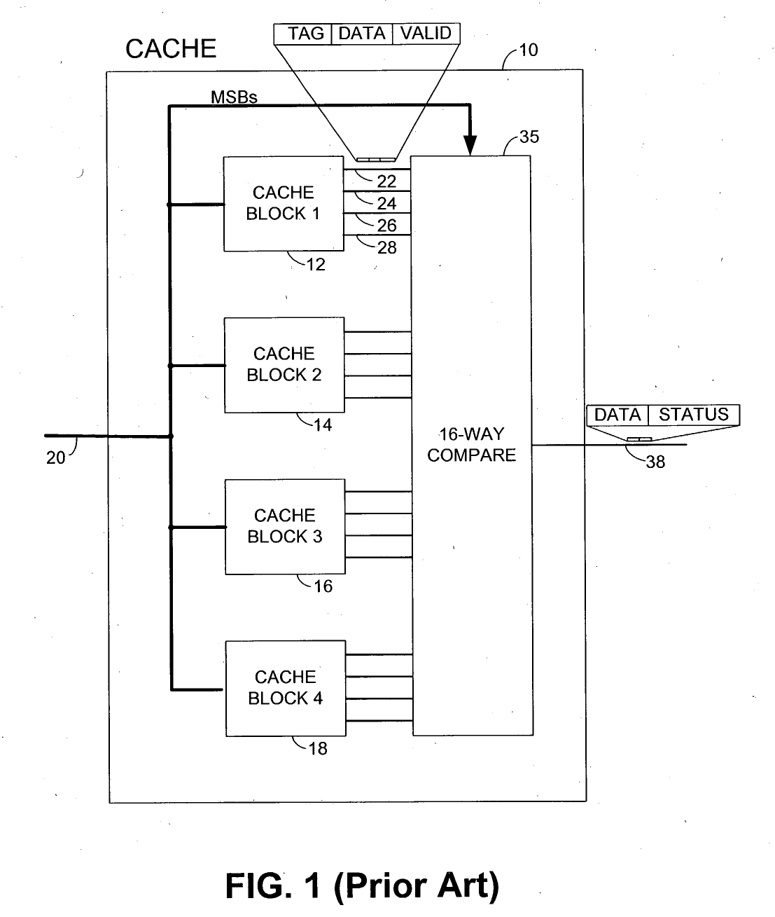

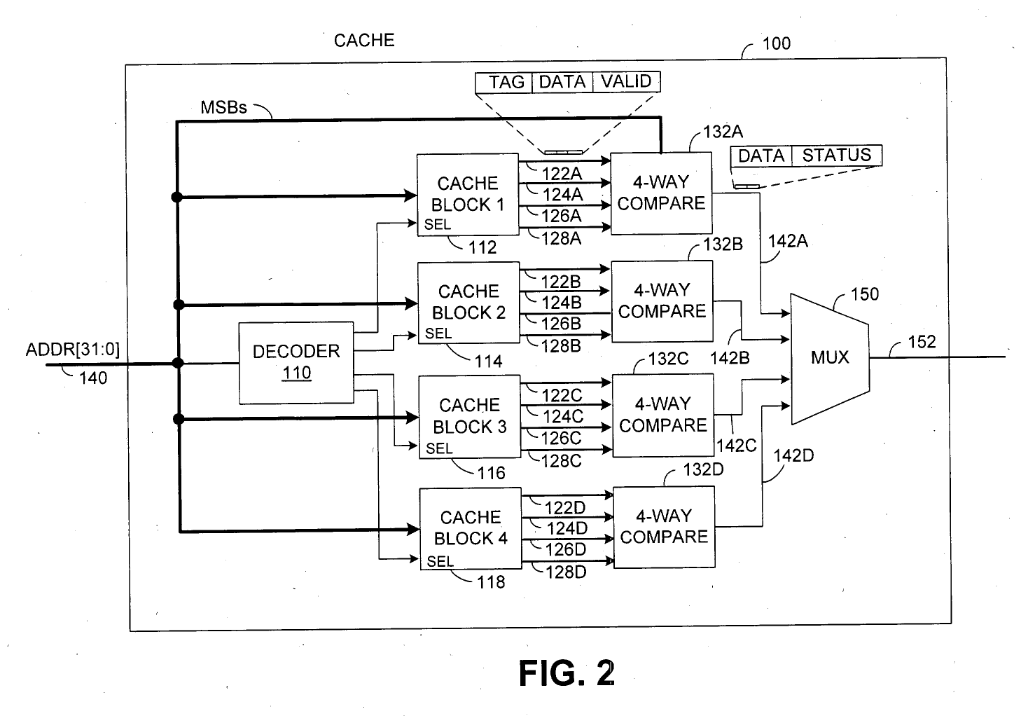

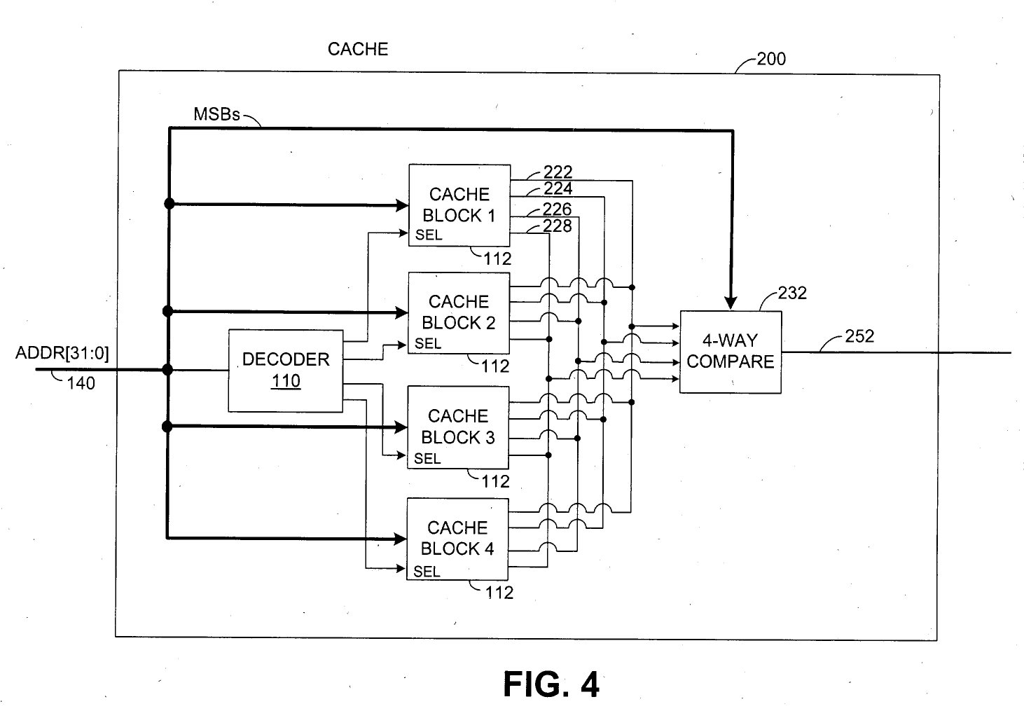

Reference is now made to FIG. 2, which is a block diagram illustrating the internal architecture of a cache memory 100 constructed in accordance with one embodiment of the present invention. Before describing the details of this diagram, or other embodiments, it is noted that the diagrams provided herein are not intended to be limiting upon the scope and spirit of the present invention. Indeed, the embodiments illustrated in FIGS. 2 and 4 have been selected for illustration for more ready comparison to the prior art illustrated in FIG. 1. In this regard, the cache block size and number of cache blocks of each of the embodiments of FIGS. 2 and 4 are the same as illustrated in FIG. 1. However, as should be appreciated by persons skilled in the art, the present invention is not limited by the particular size or number of the cache blocks utilized. Indeed, the concepts of the present invention are readily applicable to cache memory architectures having a variety of different sized cache blocks as well as various number of cache blocks. Further, the internal structure and operation of the various logic blocks illustrated in FIGS. 2 and 4 (e.g., the internal structures of cache blocks and comparison logic) are either known or readily implementable by persons skilled in the art, without the need to conduct an undue amount of experimentation. Consequently, the internal architecture and operation of these components need not be described herein.

Turning now to the diagram of FIG. 2, a cache memory 100 is illustrated having a plurality of cache blocks (four in the illustrated embodiment) 112, 114, 116, and 118. The structure and operation of these cache blocks is similar to the cache blocks illustrated and described in connection with FIG. 1. However, one significant difference relating to the operation of the present invention is that the cache blocks 112, 114, 116, and 118 of FIG. 2 may be controllably operated for operation in either an active, normal-power mode of operation or an inactive, low-power mode of operation. In the preferred embodiment, the operation of the plurality of cache blocks is synchronized or controlled such that no more than one cache block 112, 114, 116, 118 is operative in the active, normal-power mode of operation at any given time, while the remaining unselected cache blocks are placed in an inactive, low-power mode of operation.

There are many electronic devices that have circuitry configured to operate in low-power or “sleep” modes of operation, in which the electronic circuitry draws extremely little power. As is known, CMOS logic is particularly suitable for such applications. This type of known circuitry or technology may be utilized in the implementation of cache blocks 112, 114, 116, 118. Since the design of circuitry to operate in such low-power modes is known, it need not be described herein in order for persons skilled in the art to implement such technology in the cache blocks of the cache memory 100.

In the illustrated embodiment, the control of the cache block selection is implemented through the use of a decoder 110. In the embodiment of FIG. 2, having four cache blocks, a decoder 110 having four outputs is utilized. One output of the decoder is electrically coupled to the input (e.g., a select control line) of each cache block 112, 114, 116, 118. As is known, such a decoder 110 has two logic inputs and the collective value of those logic inputs determines the value of the outputs. For example, if both inputs are a logic zero, then the output connected to the select input of cache block 112 is asserted, while the remaining three outputs of the decoder 110 are de-asserted. If the logic value of the two inputs input to the decoder are logic zero and one, then the decoder 110 asserts the output electrically connected to the select line of cache block 114, while de-asserting the remaining outputs. Similarly, if the logic inputs to the decoder 110 have values of logic one and zero, then the decoder 110 asserts the output line electrically connected to the select input of cache block 116, while de-asserting the remaining outputs. Finally, if both inputs to the decoder 110 are a logic one value, then output of the decoder 110 electrically connected to the select line of cache block 118 is asserted, while the remaining decoder outputs are de-asserted.

In one implementation, two signal lines of the address bus 140 are input to the decoder 110. Accordingly, the decoder 110 is readily configured to ensure that only one cache block 112, 114, 116, 118 is selected for normal-power operation at a given time, while the remaining three cache blocks are operated in an inactive low-power mode of operation. Since the cache blocks comprise the vast majority of the logic gates within the cache memory 100 (due to the memory storage areas contained therein), operating three of these four logic blocks in a low-power mode of operation at all times results in substantial power savings for the overall cache memory 100. Indeed, as should be appreciated from the discussion herein, the cache memory 100 of the illustrated embodiment operates at approximately twenty-five percent of the power normally consumed by a comparable cache memory not implementing the invention. In many applications, such as portable electronic devices, and other battery-operated electronic devices, this power savings results in a significant extension in the battery-life.

With regard to the values carried on the address bus 140, it will be appreciated that the address may be either a physical address or a virtual address that is mapped to a physical address. Such mapping occurs may be implemented outside the components illustrated herein, as any such mapping does not impact the scope or content of the present invention. In this regard, the present invention, as illustrated and described herein, performs equally well using either physical or virtual addresses.

As further illustrated in FIG. 2, each cache block 112, 114, 116, 118 is organized to have four internal data areas (data areas not specifically illustrated), and therefore four outputs 122, 124, 126, and 128 that are directed to comparison logic 132. Each of these outputs can carry data, tag, and status information from the associated cache block to the associated comparison logic. The outputs are illustrated as single lines in the figures, but it will be appreciated that they are, in implementation, communication paths that will comprise multiple signal lines. Further, in a preferred embodiment, each of these outputs will carry data, tag, and status information. However, consistent with the scope and spirit of the invention, in an alternative embodiment, the outputs may communicate (initially) only tag and status information to the comparison logic 132. Data may later be retrieved from the cache blocks, if, based on the comparison of the tag and status information, a “hit” is detected.

Rather than the 16-way comparison performed by the comparison logic of FIG. 1, each comparison logic block 132A, 132B, 132C, and 132D need only make a four-way comparison. The logic required for implementing such a four-way comparison is significantly simplified and reduced over that required to make a 16-way comparison. However, like the embodiment illustrated in FIG. 1, and known in the prior art, the most significant bits of the address bus 140 are electrically connected or coupled to each comparison logic block. These most significant bits carried on the address bus 140 are compared with the address tags carried on each output of the corresponding cache block. As illustrated, cache block 112 corresponds to (or is associated with) comparison logic 132A. Likewise, cache block 114 corresponds to comparison logic 132B. Likewise, cache blocks 116 and 118 correspond with comparison logic 132C and 132D, respectively.

In one embodiment, the comparison logic blocks 132A-132D may be configured to operate in low-power modes of operation as well. In such an embodiment, the comparison logic blocks that are associated with all of the deselected cache blocks may be configured to operate in an inactive, low-power mode for further power savings.

Each comparison logic block 132A-132D has an output 142A, 142B, 142C, and 142D that is coupled to logic for directing data carried on one of those four outputs to the output 152 of the cache 100. In the illustrated embodiment, this logic is implemented through a multiplexor 150. In implementation, the same two bit positions of the address bus 140 that are input in to the decoder 110 may be used for the multiplexor select lines, thereby directing to the output 150 of the cache the output 142 of the compare logic 132 associated with the cache block selected by the decoder 110. Thus, when the two address bit positions, through decoder 111, control the selection of cache block 112 for operation in the normal-power mode, these same address bit positions control the multiplexor 150 to direct the information on output 142A of comparison logic 132A to be output from the cache 100 on output 152. In the illustrated embodiment of FIG. 2, where the cache memory 100 includes four cache blocks 112, 114, 116, 118, each containing four sets of one kilobyte data areas (for a total of a 16-kilobyte cache), then the tenth and eleventh address bit positions may be used for controlling the decoder 110 selection as well as the multiplexor 150 selection.

Again, the concepts of the present invention are readily extendable to other cache architectures as well. For example, a cache memory architecture having eight cache blocks may be implemented. In such an embodiment, three address bit positions may be utilized by the decoder 100 and multiplexor 150 for carrying out the appropriate selections of those cache blocks. Likewise, cache blocks having differing sizes or differing number of internal sets (e.g., 8-way associativity) of data may likewise be implemented.

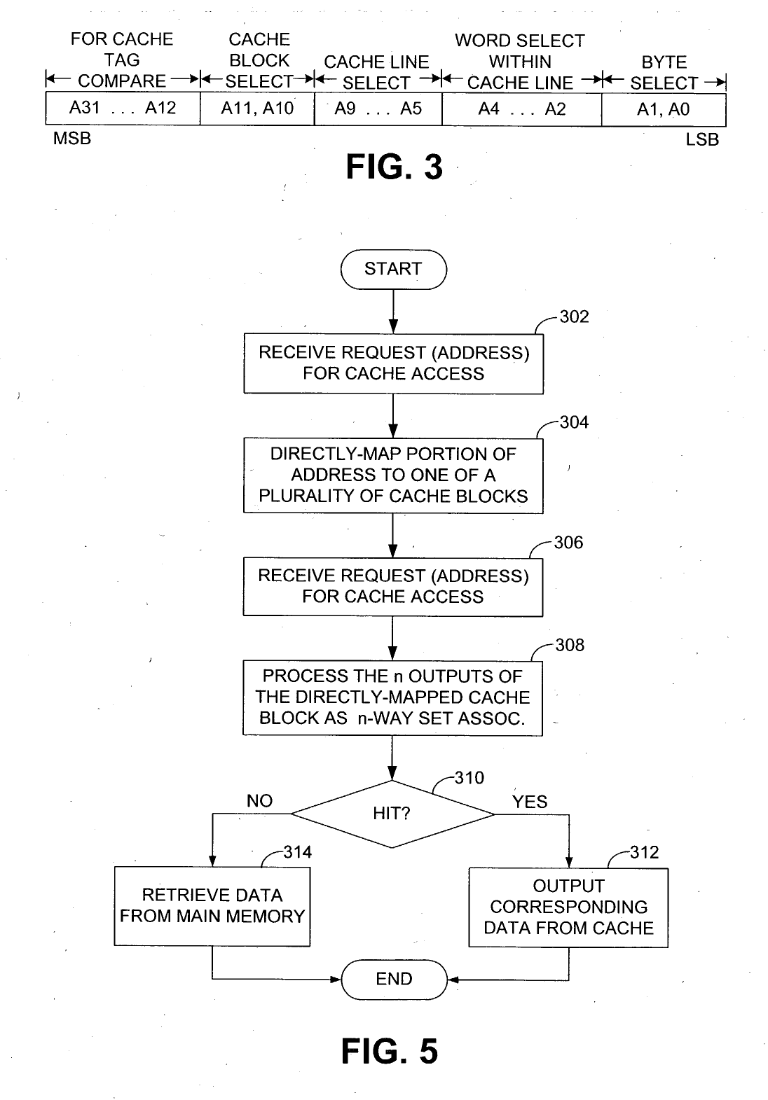

Reference is made briefly to FIG. 3, which illustrates the preferred organization of the address bit positions for the cache memory of FIG. 2. A 32-bit address architecture may be defined by the nomenclature ADDR[31:0], where ADDR[31] represents the most significant bit, and ADDR[0] represents the least significant bit. Therefore, the two least-significant address bits (ADDR[1:0]) may be used to define the byte selection within a given cache line. Likewise, address bits ADDR[4:2] may be used to define the word selection within a given cache line. In turn, address bits ADDR[9:5] may be used to designate the cache line within the data storage area. In this regard, and as mentioned previously, the preferred internal data area layout for the cache blocks of the cache architecture of FIG. 2 include eight word cache lines, thereby requiring three bits for word identification or designation within a given cache line. Likewise, with each data area having thirty-two cache lines, five bits (e.g., ADDR[9:5]) are required for designation or selection of a given cache line. Therefore, collectively address bits ADDR[9:0] can be used to specifically identify any byte within the data area(s) of each cache block 112, 114, 116, 118. In addition, address bits ADDR[11:10] provide the inputs to the decoder 110 and multiplexor 150 for controlling the selection/activation of the relevant cache block, as well as the output selection from the relevant comparison logic, respectively. Finally, address bits ADDR[31:12] form the most significant bits of the address bus 140, which may be input to each of the comparison logic blocks 132A-132D for comparison to the tags that are output on each of the output lines from the cache blocks 112, 114, 116, 118.

It should be appreciated from the foregoing description that the cache memory 100 embodies a hybrid architecture, which combines an aspect of both direct-mapped caching as well as set-associative caching. In this regard, a decoder 110 and cache blocks 112, 114, 116, 118 combine to form a direct-mapped portion of a cache, whereby address bits 10 and 11 of the address bus 140 define the specific cache block that an incoming address maps to. Circuitry within the cache memory 100 operates to place the selected cache block in an active, normal-power mode of operation, while at the same time placing the remaining three cache blocks in an inactive, low-power mode of operation. Thereafter, the comparison logic 132 that is associated with the selected cache block operates in a set-associative fashion. The selected cache block outputs a plurality of data values and associated tags, which are compared by the associated comparison logic 132 with the most significant bits of the address bus 140 (along with a data valid status bit or indicator output from the cache block) to determine whether a cache “hit” has occurred. The output of the associated comparison logic 132 is then routed to the output 152 of the cache memory 100 via multiplexor 150.

The architecture of the cache memory 100 reflects certain design tradeoffs. By disabling the effective operation of three of the four cache blocks 112, 114, 116, 118, a slight drop in the hit rate results from that which would otherwise be attained if all cache blocks 112, 114, 116, 118 remained operative. That is, cache architectures like that illustrated in FIG. 1, in many implementations, will achieve a slightly higher hit rate than the architecture of FIG. 2. However, the architecture of FIG. 2 realizes significant power reduction over the architecture illustrated in FIG. 1, and is therefore desirable for many applications in battery-operated devices or portable electronic devices, where minimal power consumption is a significant factor. Furthermore, the slight performance sacrifice in having a slightly lower hit rate in the cache architecture of FIG. 2 will often be, as a practical matter, unnoticed by the user of the electronic device, whereas benefits such as increased battery life resulting from the significantly reduced power consumption will be readily apparent.

As mentioned above, the present invention is not limited to the architecture of FIG. 2, but is readily applicable to other architectures as well. For example, differing cache block sizes, differing number of cache blocks, and differing levels of associativity may all be readily varied, consistent with the scope and spirit of the invention. Other modifications, consistent with the inventive concepts, may also be made. In this regard, reference is made to FIG. 4, which is a block diagram of a cache architecture having a size and structure (in terms of cache blocks) similar to that illustrated in FIG. 2, but illustrating an alternative embodiment of the present invention. In FIG. 4, like reference numerals have been used to designate like components. Therefore, the discussion of the structure and operation of components already described in connection with FIG. 2 need not be re-described in connection with FIG. 4. Instead, the brief discussion below will focus only on the difference between the two embodiments.

Significantly, the principal difference in the architectures between the embodiment of FIG. 4 and the embodiment of FIG. 2 relates to the output portion of the cache. In the embodiment of FIG. 2, a comparison logic block 132A, 132B, 132C, and 132D was associated with each individual cache block. The outputs of each cache block were directed to the associated comparison logic for comparison, and the output of the comparison logic 132 was routed through a multiplexor 150 to the output 152. It is observed, however, that at any given time, three of the four comparison logic blocks 132A-132D will be functionally inoperative, as the associated cache blocks will be controlled for operation in an inactive, low-power mode. Accordingly, consistent with the scope and spirit of the invention, an alternative embodiment may be implemented having only a single comparison logic block 232. As illustrated in FIG. 4, the outputs 222, 224, 226, and 228 of a given cache block may be electrically connected with the corresponding outputs of the remaining cache blocks, and each of these outputs may be input to the comparison logic 232. Depending upon the manner chosen to implement the low-power mode of operation of the various cache blocks, pull down resistors may also be attached to each of the outputs 222, 224, 226, and 228. However, if the low-power mode of operation for the various cache blocks simply results in their outputs floating (e.g., high impedance, tri-state), then the outputs of the sole active cache block will be sufficient to drive the signal paths 222, 224, 226, and 228 without the need for external pull-up or pull-down resistors. The structure of FIG. 4 operates under the recognition that no more than one of the cache blocks will be operating in an active mode of operation at any given time, allowing the outputs thereof to be electrically connected, and therefore reduce the amount of comparison logic required for implementing the comparison function.

The comparison logic 232 compares the tag (and valid status) values on each of the signal paths 222, 224, 226, and 228 with the most significant bits of the address bus 140. If a match is found, for a valid tag, then the comparison logic 232 indicates a hit and places the corresponding data on the cache output 252.

Having described certain architectural embodiments of the present invention, reference is now made to FIG. 5, which is a flowchart illustrating the top-level functional operation of a method constructed in accordance with an embodiment of the invention. In accordance with this embodiment, the cache receives a request (which includes a address) to access data within the cache (e.g., a data read instruction) (step 302). A portion of the address is then directly mapped to select one of a plurality of cache blocks, each of which store associative sets of data (step 304). The directly mapped (or selected) cache block is enabled to operate in an active, normal-power mode of operation. The remaining, unselected cache blocks, however, are placed in an inactive, low-power mode of operation (step 306). In a manner that is known, and described above, the selected cache block processes the address bits input to it and outputs corresponding data, tags, and status bits for each of the internal sets of data corresponding to the input address. Assuming that there are n (where n is an integer) sets of data within the cache block, then the cache block outputs n sets of corresponding data, tags, and status bits on n outputs.

The method then processes the n outputs of the directly-mapped cache block as an n-way set associative caching function (step 308). Stated another way, the cache compares the tag values for each valid output of the selected cache block to determine if any of those tags matches a portion (e.g., most significant bits) of the address input to the cache (step 310). If a match is, indeed, found, then a cache “hit” is deemed to have occurred, and the corresponding data from the data set of the tag that resulted in the hit is output from the cache (step 312). If, however, no hit is deemed to have occurred, then the data from the requested address is retrieved from main memory (step 314).

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

What is claimed is:

1. A cache comprising:
a plurality of cache blocks, each cache block comprising a plurality of data lines having multi-way associativity, each cache block further comprising a plurality of outputs;
first logic for selecting only one of the plurality of cache blocks to be operative at a given time;
comparison logic associated with each of the plurality of cache blocks, each comparison logic having a plurality of inputs for receiving the plurality of outputs of the associated cache block and configured to compare the plurality of outputs of the associated cache block with a plurality of bit positions of an address bus that is input to the cache; and
second logic for selecting an output from one of the comparison logic to direct to an output of the cache.

2. The cache as defined in claim 1, wherein the first logic comprises a decoder.

3. The cache as defined in claim 2, wherein at least one address line of the address bus input to the cache is input to the decoder to control the one cache block that is selected to be operative at the given time.

4. The cache as defined in claim 1, wherein the second logic comprises a multiplexor.

5. The cache as defined in claim 4, wherein at least one address line of the address bus input to the cache is input to the multiplexor to control the one comparison logic output that is directed to an output of the cache.

6. The cache as defined in claim 3, wherein the second logic comprises a multiplexor and wherein the same at least one address line of the address input to the cache is input to the multiplexor to control the one comparison logic output that is directed to an output of the cache.

7. The cache as defined in claim 1, wherein the number of the plurality of cache blocks is a power of two.

8. The cache as defined in claim 1, wherein there are four cache blocks.

9. The cache as defined in claim 1, wherein each of the plurality of cache blocks is configured as a four-way set associative block having eight data words and thirty-two lines of data.

10. The cache as defined in claim 1, wherein each of the outputs of the plurality of cache blocks includes a cache tag, corresponding data, and at least one corresponding status bit.

11. The cache as defined in claim 10, wherein the comparison logic is configured to compare the tag portion of the plurality of outputs of the corresponding cache block to a portion of the address bus input to the cache.

12. The cache as defined in claim 10, wherein each comparison logic is capable of outputting data output on one of the plurality of outputs from the corresponding cache block, if the tag portion of the one output matches a portion of the address bus input into the cache.

13. The cache as defined in claim 1, wherein each comparison logic is configured to output data and at least one status bit, the at least one status bit indicating whether the cache data is valid.

14. The cache as defined in claim 1, wherein the plurality of cache blocks are configured so that only a selected one of the cache blocks is operative in normal-power mode of operation at any given time, and that all remaining cache blocks are operative in an inactive, low-power mode of operation.

15. A portable electronic device comprising:
a processor,
a memory; and
a cache comprising:
a plurality of cache blocks, each cache block comprising a plurality of data lines having multi-way associativity, each cache block further comprising a plurality of outputs;
first logic for selecting only one of the plurality of cache blocks to be operative at a given time;
comparison logic associated with each of the plurality of cache blocks, each comparison logic having a plurality of inputs for receiving the plurality of outputs of the associated cache block and configured to compare the plurality of outputs of the associated cache block with a plurality of bit positions of an address bus that is input to the cache; and
second logic for selecting an output from one of the comparison logic to direct to an output of the cache.

16. A cache comprising:
a plurality of cache blocks that are independently selected using a direct-mapped cache access, each block capable of storing a plurality of cache lines and having a plurality of outputs;
comparison logic associated with each of the plurality of cache blocks, each comparison logic having a plurality of inputs for receiving the plurality of outputs of the associated cache block and configured to compare the plurality of outputs of the associated cache block with a value on a portion of an address bus that is input to the cache; and
output logic for outputting from the cache an output from the comparison logic that is associated with a selected cache block

17. The cache as defined in claim 16, further including select logic for controlling which of the plurality of cache blocks are selected, the select logic being configured to ensure that no more than one of the cache blocks is selected at any given time, and wherein all cache blocks that are not selected are maintained in an inactive, low-power mode.

18. The cache as defined in claim 17, wherein the select logic comprises a decoder.

19. The cache as defined in claim 16, wherein the output logic comprises a multiplexor.

20. The cache as defined in claim 17, wherein the output logic comprises a multiplexor, and wherein a portion of the address bus that is input to the cache is used to control both the decoder and the multiplexor.

21. The cache as defined in claim 16, wherein there are four cache blocks, each cache block having four outputs.

22. A hybrid cache comprising:
an input portion comprising a plurality of cache blocks configured to be independently selected using a direct-mapped cache access, each cache block capable of storing a plurality of cache lines and having a plurality of outputs;
an output portion comprising comparison logic and configured to compare the plurality of outputs of the selected cache block with a value carried on a portion of an address bus that is input to the cache, the output portion further capable of outputting from the cache data that is output from the selected cache block.

23. The hybrid cache as defined in claim 22, wherein the input portion comprises a decoder configured to receive a portion of an address input in to the hybrid cache and output a plurality of select signal lines, wherein each one of the plurality of select signal lines is electrically connected to one of the plurality of cache blocks.

24. The hybrid cache as defined in claim 23, wherein each of the plurality of cache blocks is capable of entering an inactive, low-power operation, in response to a state of the electrically connected select signal line.

25. The hybrid cache as defined in claim 22, wherein the input portion is configured to ensure that a maximum of one of the plurality of cache blocks operates in an active, normal-power mode of operation at any given time, and that all remaining plurality of cache blocks operate in an inactive, low-power mode.

26. The hybrid cache as defined in claim 22, wherein the output portion comprises comparison logic associated with each of the plurality of cache blocks, each comparison logic having a plurality of inputs for receiving the plurality of outputs of the associated block and configured to compare information on each of the plurality of outputs of the associated block with a plurality of bit positions of an address bus that is input to the cache.

27. The hybrid cache as defined in claim 26, wherein the output portion further comprises a multiplexor configured to direct an output of the comparison logic associated with an independently-selected cache block to an output of the hybrid cache.

28. The hybrid cache as defined in claim 22, wherein the output portion comprises comparison logic having a plurality of inputs for receiving the plurality of outputs of the independently-selected cache block, the comparison logic being configured to compare information on each of the plurality of outputs of the associated block with a plurality of bit positions of an address bus that is input to the cache.

29. The hybrid cache as defined in claim 28, wherein the comparison logic comprises an output that is directly coupled to an output of the hybrid cache.

30. A method for caching data comprising:
directly mapping an address input to the cache to one of a plurality of cache blocks, each cache block having n outputs; and
processing the n outputs of the directly-mapped cache as an n-way set associative cache.

31. The method as defined in claim 30, further comprising operating all non directly-mapped cache blocks in an inactive, low-power mode.

32. The method as defined in claim 30, further comprising ensuring that no more than one of the plurality of cache blocks is operative in an active, normal-power mode of operation at any given time.

33. The method as defined in claim 30, further including outputting from the cache data within the directly-mapped cache block corresponding to the address, if the processing step determines that a hit has occurred.

34. The method as defined in claim 30, wherein the processing comprises comparing a tag portion of each of the n outputs with a portion of the address input to the cache.

35. The method as defined in claim 33, wherein the outputting further includes outputting from the cache at least one status bit associated with the data.

36. The method as defined in claim 30, wherein the directly mapping includes inputting a portion of the address into a decoder.
